(19) United States
(12) Patent Application Publication
(10) Pub. No.: US 2003/0208883 A1
(43) Pub. Date: Nov. 13, 2003

(54) Lightweight extendable handle for demolition tools

(76) Inventor: Andrew S. Ruhland, Spring Lake, NC (US)

Correspondence Address: Andrew S. Ruhland, 120 Mockingbird LN., SPRING LAKE, NC, 28390, US

(21) Appl. No.: 10/139,543

(22) Filed: May 7, 2002

(51) Int. Cl. E05B 1/00

(52) U.S. Cl. 16/422

(57) ABSTRACT

An extendable tool handle with a hollow gripping handle (1) comprised of 2024 T3 aluminum with a knurled segment (2), through which an extendable slide shaft (3) comprised of 6AL 4V titanium with a longitudinal slide groove (4) may travel. The slide shaft (3) can be locked in either the extended or collapsed position by means of a lock comprising a spring plate (5), and spring cap (6) of 2024 T3 aluminum, and a 19/64 button head screw (8).

### CROSS-REFERENCE TO RELATED APPLICATIONS

Not Applicable

### BACKGROUND—FIELD OF INVENTION

This invention relates to the field of hand-tool handles that may be affixed to various types of demolition or wrecking tools.

### BACKGROUND—DESCRIPTION OF PRIOR ART

There are a number of manufacturers of demolition or wrecking tools in a class that are generally called “hooligan”devices. These consist of a heavy forged tool head with several sharp tapered protrusions affixed to a long handle of metal or wood. They are commonly employed by fire departments, rescue crews, police “SWAT” teams, or military “special forces” groups. They are generally used to force entry through a secured door, window, or to create an opening to an interior space. The handle affixed to the devices is generally long, thirty inches or more, this is necessary to facilitate two-handed operation in order for the operator to be able to impart sufficient energy to the tool for it to operate effectively. While a number of variations have been employed with respect to the tool head, or working portion of the device, no improvement has been attempted with respect to the handle portion of the device. Therefore all of the devices of this class heretofore known suffer for distinct disadvantages with respect to the handle portion of the device:

(a) The nature of the designed use for these tools necessitates that the handle be of sturdy design and stout materials, or the handle-to-tool interface will fail, or the handle itself will fail. A wooden handle can crack and a metal handle bend or fracture.

(b) The heavy weight of the handle contributes significantly to the overall tool weight, which in turn can lead to operator fatigue. This is especially significant in situations where the tool must be carried long distances before it can even be utilized.

(c) The long handle, besides contributing to overall weight, can also contribute to bulk of the tool and can make it cumbersome to carry or transport.

### SUMMARY

In accordance with the present invention a lightweight extendable handle for demolition tools consists of a hollow tube through which an extendable handle can slide and lock in either the collapsed or extended position.

### OBJECTS AND ADVANTAGES

Accordingly, besides to objects and advantages of the lightweight extendable handle for demolition tools described in the above patent, several objects and advantages of the present invention are:

(a) to provide a demolition tool handle that is very strong and will not fracture, bend or fail, even with the most severe use.

(b) to provide a handle for a demolition tool that will be very light in weight and not contribute to operator fatigue, either while being carried or while being used.

(c) to provide a demolition tool handle that will reduce the tool handle length by fifty percent during the transport or carrying portion of tool operation, thus reducing bulk and increasing convenience significantly.

Further objects and advantages are to provide a universal handle that can be affixed to various tool head designs, so that the applications for the lightweight extendable tool handle are very broad and not limited to a single type or class of tool head. Still further objects and advantages will become evident from a consideration of the ensuing description and drawings.

### DRAWING FIGURES

In the drawings, the figures have the same numeric references.

FIG. 1 shows the extendable handle, gripping handle, top view,

FIG. 1A shows the extendable handle, gripping handle, side view.

FIG. 2 shows the extendable handle, slide shaft, top view.

FIG. 2B shows the extendable handle, slide shaft, side view.

FIG. 3 depicts the lock plate, spring plate, top view.

FIG. 4 depicts the lock plate, spring cap, top view.

### REFERENCE NUMERALS IN DRAWINGS

| | |
|---|---|
| 1 gripping handle | 2 knurled segment |
| 3 slide shaft | 4 slide groove |
| 5 spring plate | 6 spring cap |
| 7 ¼ by 20 button head screw | 8 19/64 button head screw |
| 9 pull wire | 10 mounting hole |

### DESCRIPTION—FIGS., 1, 1A, 2, 2A 3, AND 4-PREFERRED EMBODIMENT

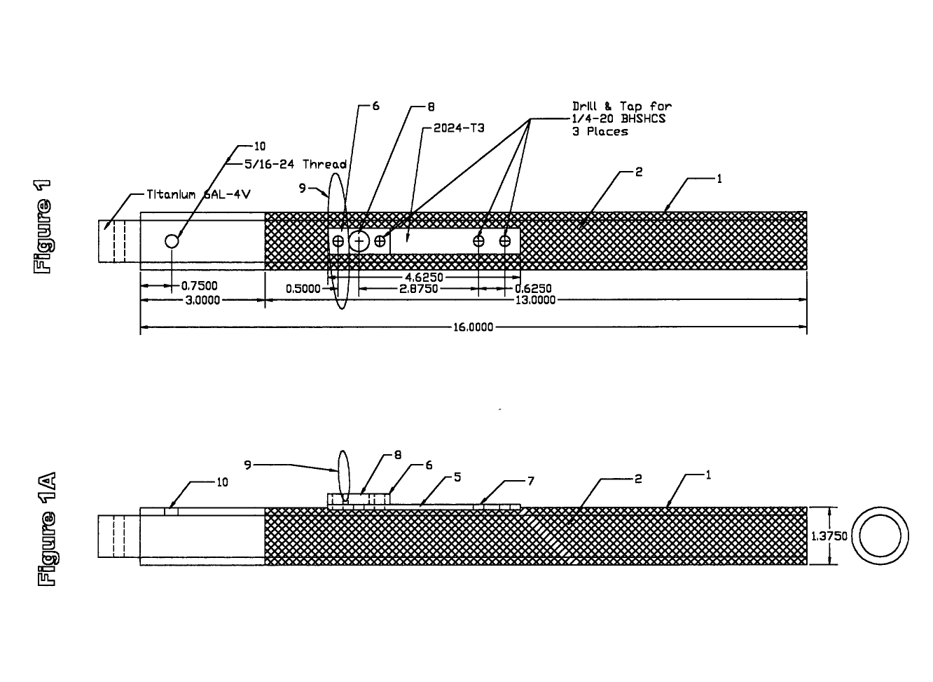

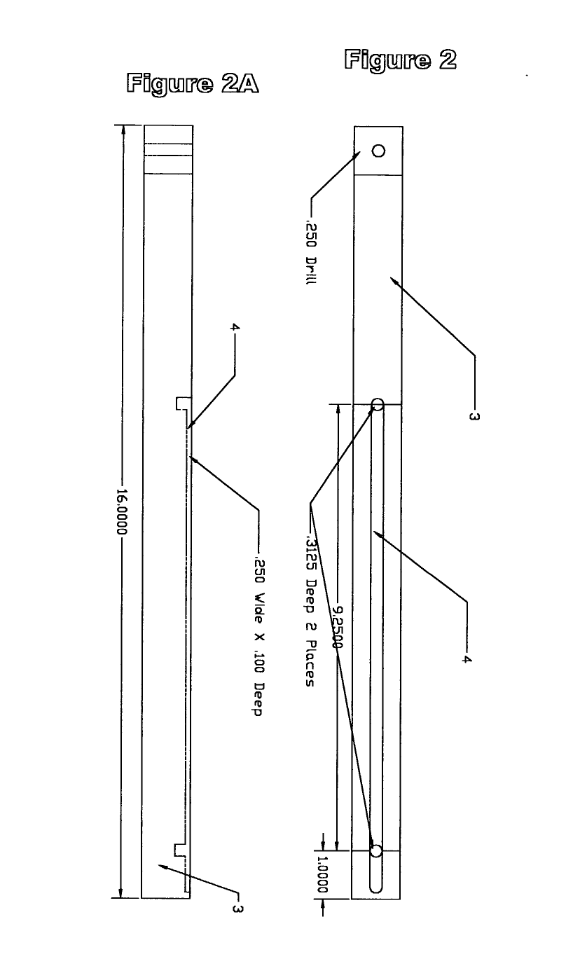

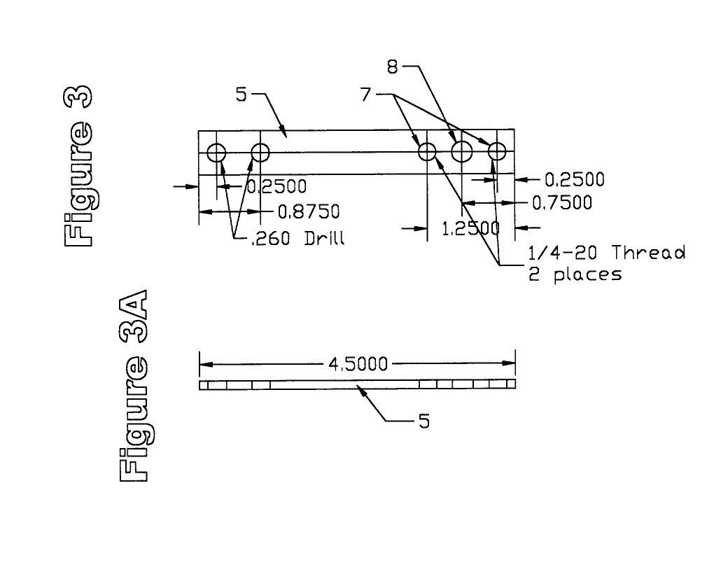

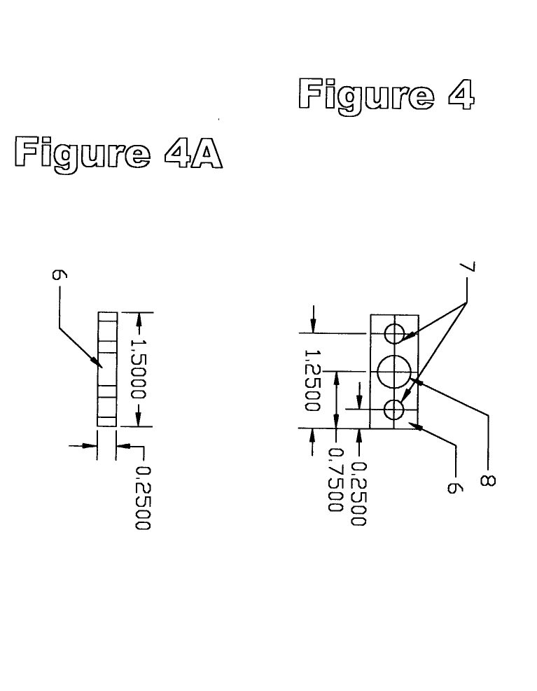

A preferred embodiment of the lightweight extendable handle for demolition tools of the present invention is illustrated in FIG. 1, gripping handle (top view), FIG. 1A (side view); FIG. 2, slide shaft (top view), FIG. 2A (side view); FIG. 3, spring plate; and FIG. 4, hinge cap. The extendable tool handle has a gripping handle (1) 16.00 inches in length, constructed of 2024 T3 aluminum tubing with 1.00 inch internal diameter. The gripping handle (1) has a 13 inch knurled segment (2) (16 turns per inch) on the bottom segment. A 19/64 inch hole is drilled through the

A slide shaft (3) of 6AL 4V titanium, 1 inch external diameter, 16.50 inches in length is finished to smoothly slide within the gripping handle (1) One longitudinal slide groove (4) 10.25 inches by 19/64 inches is machined into the slide shaft (3). A 19/64 hole is drilled below the depth of the slide groove (4) to provide a recess for the 19/64 button head screw (8) that functions to lock the slide shaft (3) in either the extended or contracted position.

The locking mechanism consists of a segment of 2024 T3 aluminum band material ¼ inch by 1.00 inch, by 4.50 inches long which functions as a spring plate (5) by means of being affixed at the bottom end to the gripping handle (1) by means of two ¼ by 20 button head screws (7) for which the gripping handle (1) has been tapped. A spring cap (6) of the same 2024 T3 aluminum material is affixed to the spring plate (5) on the free end by means of two ¼ by 20 button head screws for which it has be tapped. The spring cap (6) provides a mount for the 19/64 button head screw (8) which serves as a lock pin through which the slide groove (4) travels, and a mount for the pull wire (9), a loop of stainless steel wire, which facilitates flexing the spring plate (5) to release the slide shaft (3). The spring cap (6) in machined horizontally on the lower surface to provide a means of affixing the pull wire (9) by means of pinching it between the spring plate (5) and the spring cap (6).

A mounting hole (10) is drilled through the top end of the slide shaft (3) to facilitate affixing various tool heads.

Advantages

From the description above, a number of advantages of the lightweight extendable handle for demolition tools become evident:

(a) The extendable handle provides a sturdy handle of durable materials that will not crack or bend even in the most severe application.

(b) The extendable handle, though extremely durable, is also very light in weight, and will not contribute to operator fatigue during carrying or operation.

(c) The extendable handle reduces bulk during transportation and eliminates a long handle that is cumbersome.

Operation-FIGS. 1, 1A, 2, 2A

The manner of using the lightweight extendable handle for demolition tools is to first affix it to a tool head by means of bolting or pinning as the tool head requires. The handle may then be extended by momentarily pulling on the pull wire (9). This releases the slide shaft (3) to move freely by means of the shaft groove (4) until the handle is fully extended and locked in place as the spring plate forces the 19/64 button head screw (8) in the drilled detent hole at the end of the slide groove (4). The tool may then be used with the handle fully extended. The tool handle can be collapsed by reversing this procedure. Of course, in confined spaces the tool may be operated with the handle fully collapsed.

Conclusion, Ramification, and Scope

Accordingly the reader will see that the lightweight extendable handle for demolition tools of this invention can be used to provide a universal tool handle that can be used with many tool head applications. Furthermore, the extendable tool handle has additional advantages in that:

It provides a demolition tool handle that is very strong and will not fracture, bend or fail, even under the most severe use.

It provides a handle that is very light in weight and will not contribute to operator fatigue, either while being carried or used.

It provides a tool handle that can reduce the overall length of the tool by as much as 50% during the transport or carrying portion of tool operation, and in so doing reduce bulk and increase carrying convenience.

Although the description above contains many specificities, these should not be construed as limiting the scope of the invention, but merely as a means to provide an illustration of the presently preferred embodiments of this invention.

Thus the scope of the invention should be determined by the appended claims, and their legal equivalents, rather than the illustrations herein given.

I claim:

1. In a handle for demolition tools comprising a hollow tube through which an extendable portion can slide and lock in the extended or collapsed position.

2. In the handle of claim 1 wherein said hollow tube is comprised of 2024 T3 aluminum.

3. In the handle of claim 2 wherein said hollow tube has 1.00 inch internal diameter.

4. In the handle of claim 2 wherein said hollow tube has knurling on the lower portion.

5. In the handle of claim 1 wherein said extendable portion is comprised of 6AL 4V Titanium.

6. In the handle of claim 5 wherein said extendable portion has one 19/64 inch groove along the longitudinal aspect.

7. In the handle of claim 6 wherein a 19/64 inch hole is drilled at each end of said groove below the depth of said groove.

8. In the handle of claim 1 wherein said lock is comprised of a segment of 2024 T3 aluminum band.

9. In the handle of claim 6 wherein said lock of said aluminum segment is affixed to said hollow tube at one end.

10. In the handle of claim 8 wherein said aluminum segment has a 19/64 inch screw in the end not affixed to said hollow tube which functions as a locking device.
